(19) United States
(12) Patent Application Publication
(10) Pub. No.: US 2018/0080496 A1
(43) Pub. Date: Mar. 22, 2018

(54) Hook Arrangement Device

(71) Applicant: Sean M Early, Dubln, CA (US)

(72) Inventor: Sean M Early, Dubln, CA (US)

(21) Appl. No.: 15/268,792

(22) Filed: Sep. 19, 2016

(51) Int. Cl. F16B 45/00; A47G 25/06; A47K 10/12; F16M 13/02

(52) U.S. Cl. CPC F16B 45/00; F16M 13/02; A47K 10/12; A47G 25/0607

(57) ABSTRACT

A hook arrangement device for hanging items along a rack with (1) a generally S-shaped hook having an interior and exterior portion; (2) a first U-shaped configuration at one end of the S; (3) a plurality of mounting tabs extending from the interior portion of the first U-shaped configuration; (4) a second U-shaped configuration at the other end of the S in inverted relationship to the first U-shaped end; and (5) a U-shaped insert with an interior and exterior portion. The exterior portion of the U-shaped insert is mounted to the interior portion of the first U-shaped configuration using the mounting tabs of the interior portion of the first U-shaped configuration to allow the hook to fit over a bar or rack and thereby holding the hook in a vertical position perpendicular to the bar or rack.

### FIELD

The present invention relates in general to hook arrangement devices for hanging clothing, towels or other articles. In particular, the present invention relates to a removable hook arrangement device designed to affix to a rod or bar in order to maximize article storage space when the article is not in use.

### BACKGROUND

Traditionally, living spaces are stuck with one-dimensional standard towel/garment racks and shower door/handle racks, collectively referred to herein as “article racks”. Most new or existing article racks can only hold one or two articles at a time.

Hooks for hanging articles are well known in the prior art. However, most hooks must be used separately or independent of an existing article rack or have to be attached to a wall or door via screws, nails, tape, Velcro or some other means of permanent or semi permanent attachment. There exists a need for a hook arrangement device that allows the addition of multiple hooks to an existing article rack without having to permanently or semi permanently attach anything to walls or doors, thereby eliminating the need to find new space to attach new hooks.

### BRIEF SUMMARY OF THE INVENTION

An object of the present invention is to provide a hook arrangement device for hanging clothing towels or other articles that can be added to an existing article rack in order to securely retain the article on the hook of the device. A further object of the present invention is to provide a hook arrangement device that permits secure and simple attachment to an existing article rack, thereby eliminating the need to find other space for the hook on a wall, door or other surface.

The present invention is a hook arrangement device for hanging items along a rack comprising (1) a generally S-shaped hook having an interior and exterior portion; (2) a first U-shaped configuration at one end of the S; (3) a plurality of mounting tabs extending from the interior portion of the first U-shaped configuration; (4) a second U-shaped configuration at the other end of the S in inverted relationship to the first U-shaped end; and (5) a U-shaped insert with an interior and exterior portion. The exterior portion of the U-shaped insert is mounted to the interior portion of the first U-shaped configuration using the mounting tabs of the interior portion of the first U-shaped configuration to allow the hook to fit over a bar or rack and thereby holding the hook in a vertical position perpendicular to the bar or rack. In the preferred embodiment, the interior of the U-shaped insert is lined with a gripping material. Additionally, the second U-shaped configuration may have a spherically shaped portion protruding from its terminal end.

One significant advantage to the present invention is that the S-shaped hook may be combined with various U-shaped inserts wherein the interior shape and dimensions of the U-shaped inserts correspond to varied sized and shaped bars or racks. This allows the U-shaped insert to be exchanged as needed to allow the hook to function with a variety of bars or racks. This allows a combination of one S-shaped portion with a variety of U-shaped inserts, thereby reducing costs and materials necessary to produce a hook capable of being used on a variety of bars or racks.

### BRIEF DESCRIPTION OF THE DRAWINGS

FIG. 1 is back perspective view of the S-shaped hook portion of the present invention.

FIG. 2 is back perspective view of the S-shaped hook portion of the present invention.

FIG. 3 is a side view of the S-shaped hook portion of the present invention.

FIG. 4A is a perspective view of one embodiment of the U-shaped insert portion of the present invention.

FIG. 4B is a front view of one embodiment of the U-shaped insert portion of the present invention.

FIG. 4C is a side view of one embodiment of the U-shaped insert portion of the present invention.

FIG. 5A is a perspective view of one embodiment of the U-shaped insert portion of the present invention.

FIG. 5B is a front view of one embodiment of the U-shaped insert portion of the present invention.

FIG. 5C is a side view of one embodiment of the U-shaped insert portion of the present invention.

FIG. 6A is a perspective view of one embodiment of the U-shaped insert portion of the present invention.

FIG. 6B is a front view of one embodiment of the U-shaped insert portion of the present invention.

FIG. 6C is a side view of one embodiment of the U-shaped insert portion of the present invention.

FIG. 7A is a perspective view of one embodiment of the U-shaped insert portion of the present invention.

FIG. 7B is a front view of one embodiment of the U-shaped insert portion of the present invention.

FIG. 7C is a side view of one embodiment of the U-shaped insert portion of the present invention.

FIG. 8A is a perspective view of one embodiment of the U-shaped insert portion of the present invention.

FIG. 8B is a front view of one embodiment of the U-shaped insert portion of the present invention.

FIG. 8C is a side view of one embodiment of the U-shaped insert portion of the present invention.

FIG. 9A is a perspective view of one embodiment of the U-shaped insert portion of the present invention.

FIG. 9B is a front view of one embodiment of the U-shaped insert portion of the present invention.

FIG. 9C is a side view of one embodiment of the U-shaped insert portion of the present invention.

FIG. 10 is a side view of the U-shaped insert mounted inside the S-shaped hook.

FIG. 11 is a perspective side view of the U-shaped insert mounted inside the S-shaped hook.

### DETAILED DESCRIPTION

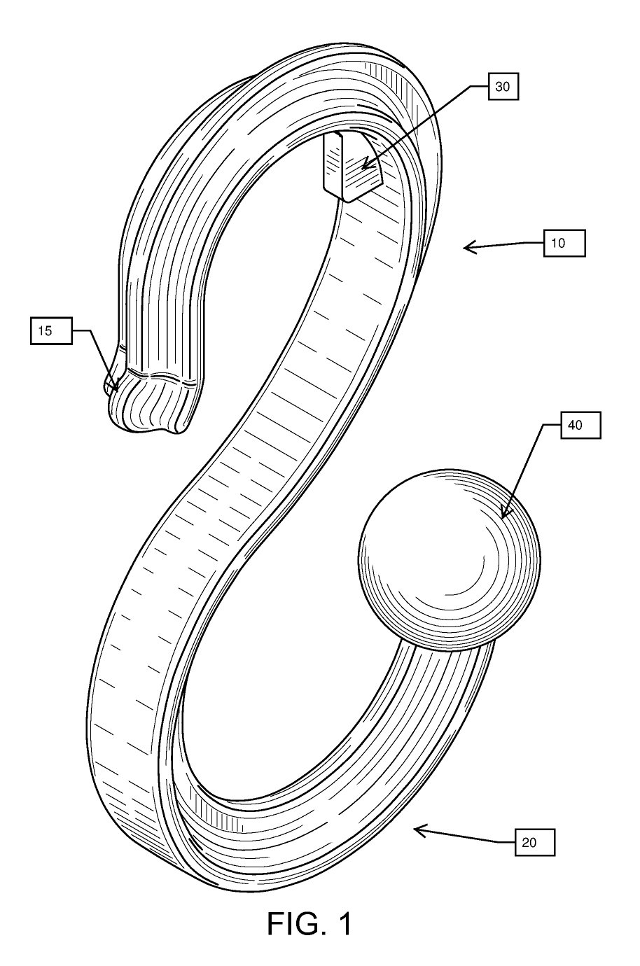

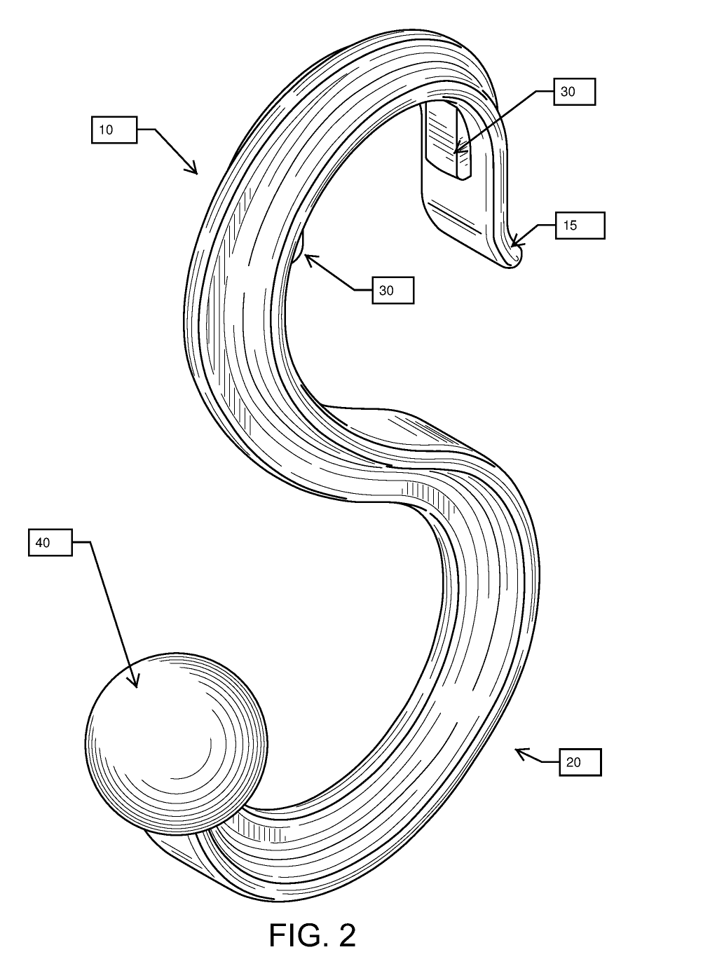

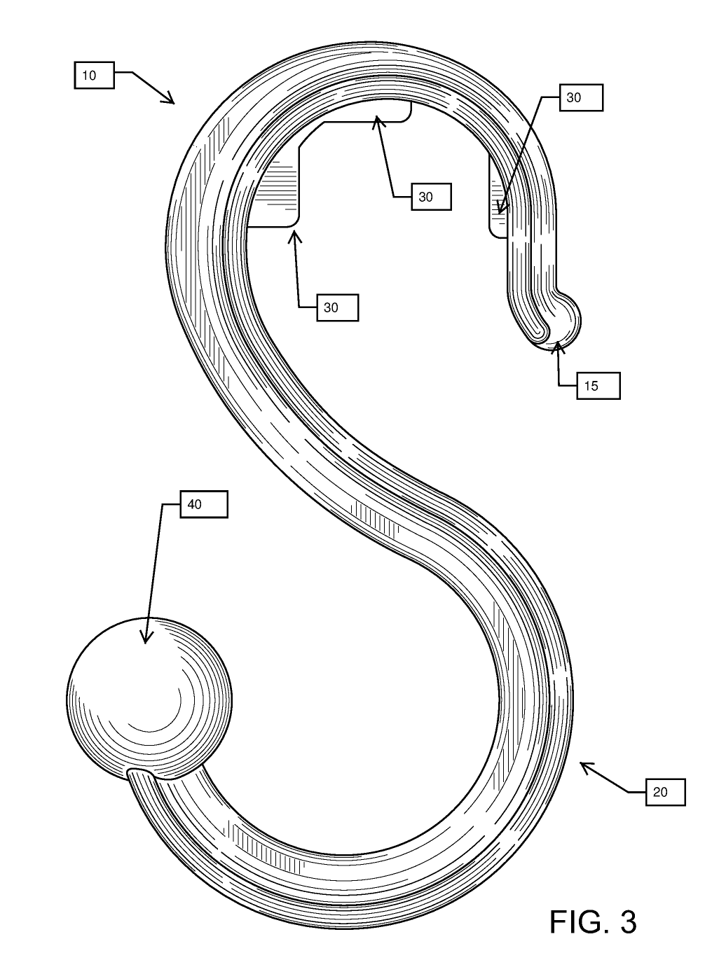

As shown in FIGS. 1-3, the hook arrangement device for hanging items along a rack has a generally S-shaped hook having an interior and exterior portion. A first U-shaped configuration 10 is at one end of the “S” having a terminal end 15. There are a plurality of mounting tabs or fins 30 extending from the interior portion of the first U-shaped configuration. A second U-shaped configuration 20 is at the other end of the “S” in inverted relationship to the first U-shaped end 10 with a terminal end 40.

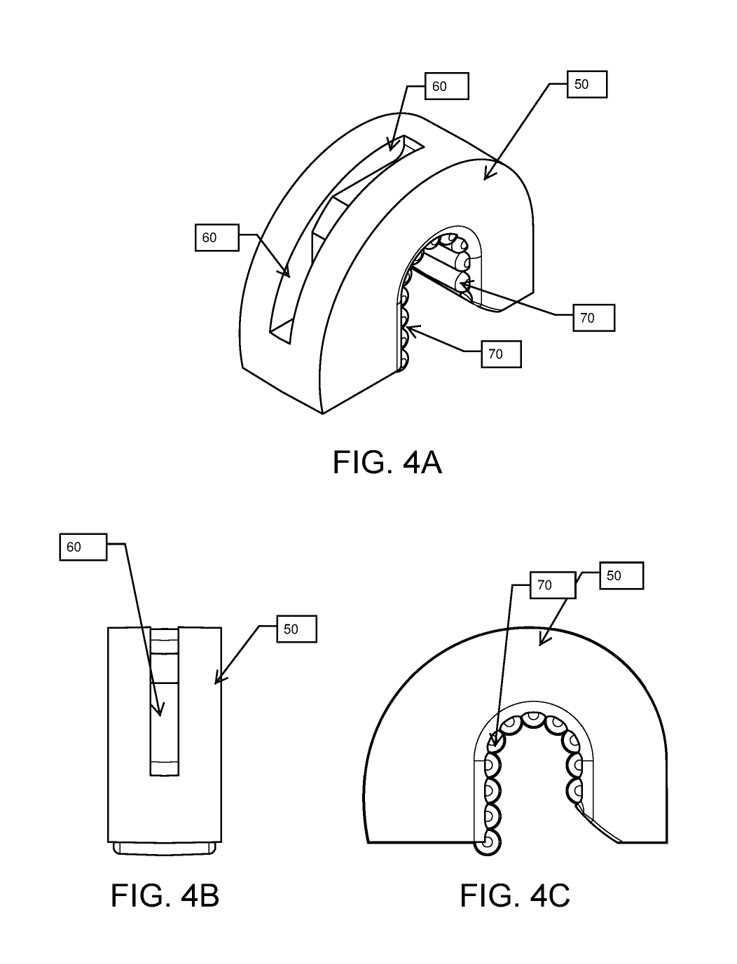

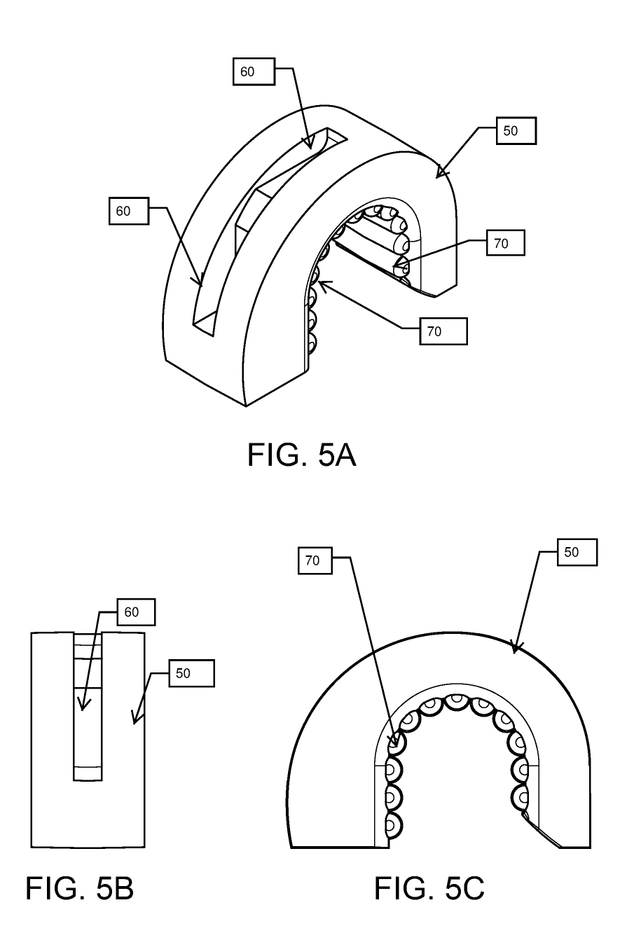

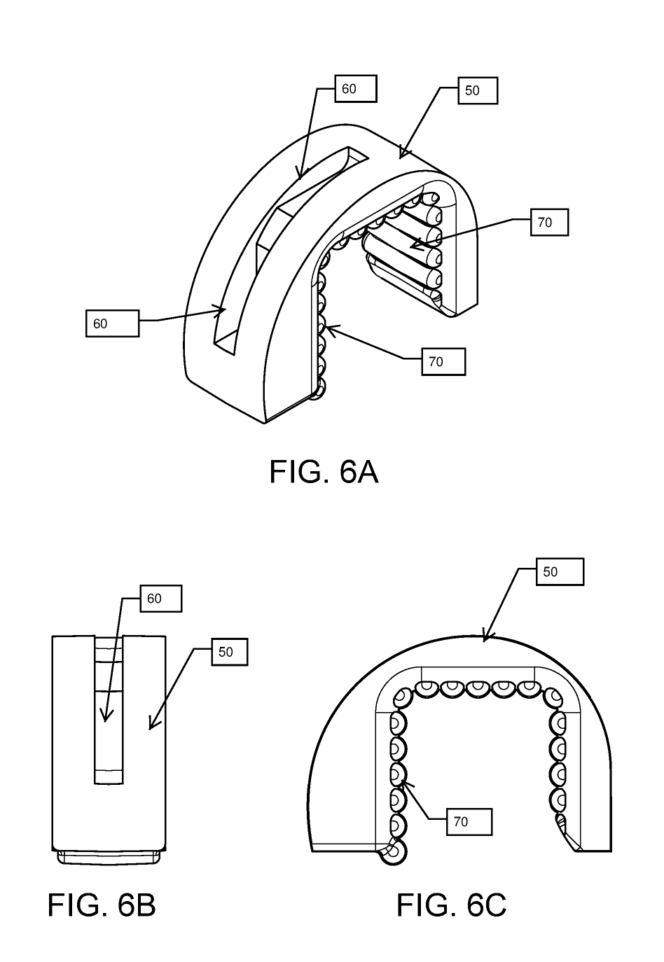

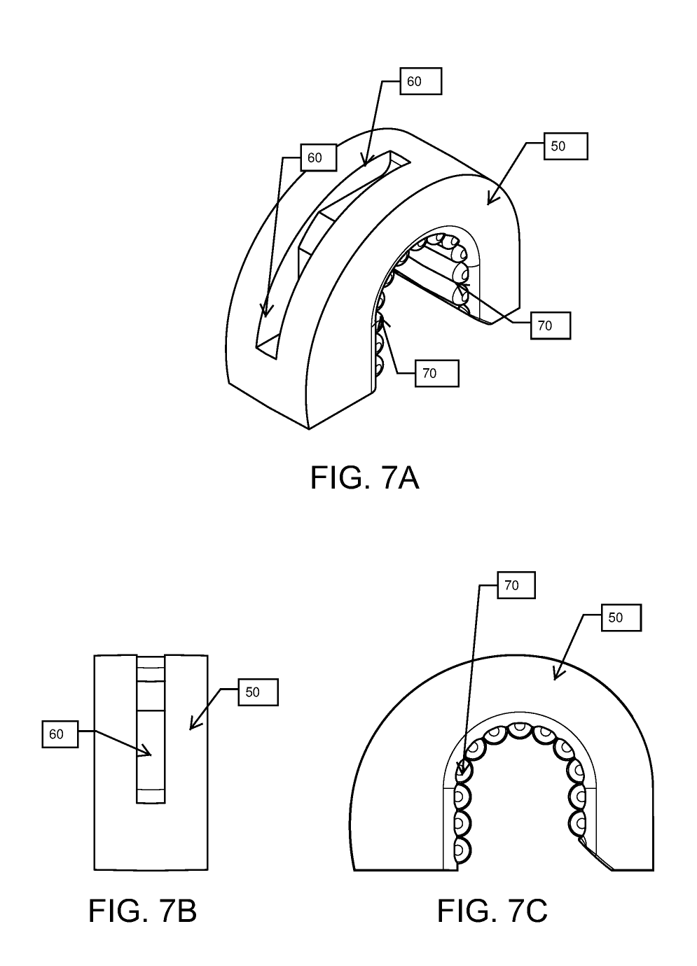

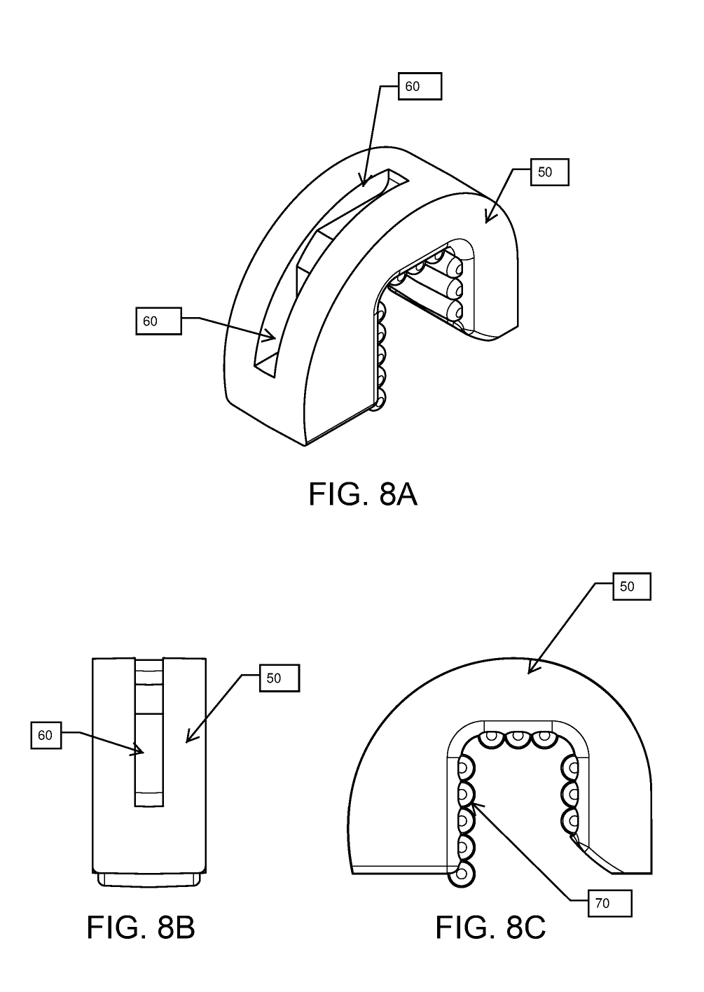

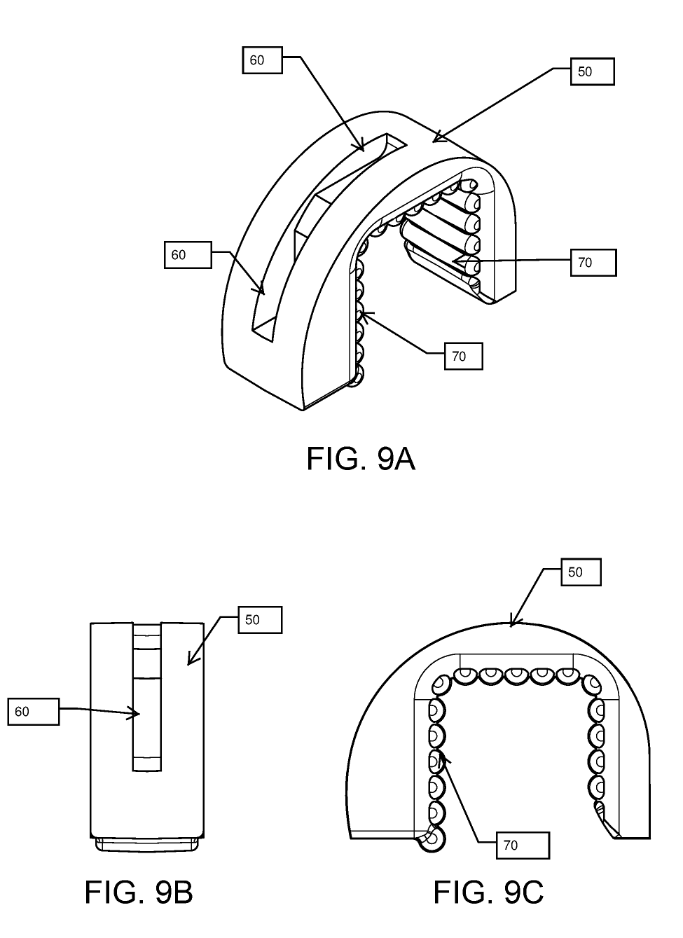

As shown generally in FIG. 4A-C, the device has a U-shaped insert with an interior and exterior portion and is comprised generally of a body 50 with recessed portions 60 on the exterior of the body 50. The recessed portions 60 align with the mounting tabs or fins 30. In the preferred embodiment, the interior of the U-shaped insert body 50 is lined with a gripping material 70. The interior portion of the U-shaped insert may have a circular cross section as shown in FIGS. 4A-C, 5A-C, 7A-C, 10 and 11. Additionally, the interior portion of the U-shaped insert may have a rectangular cross section as shown in FIGS. 6A-C, 8A-C and 9A-C. However, the cross section shape is not limited to circular or rectangular embodiments.

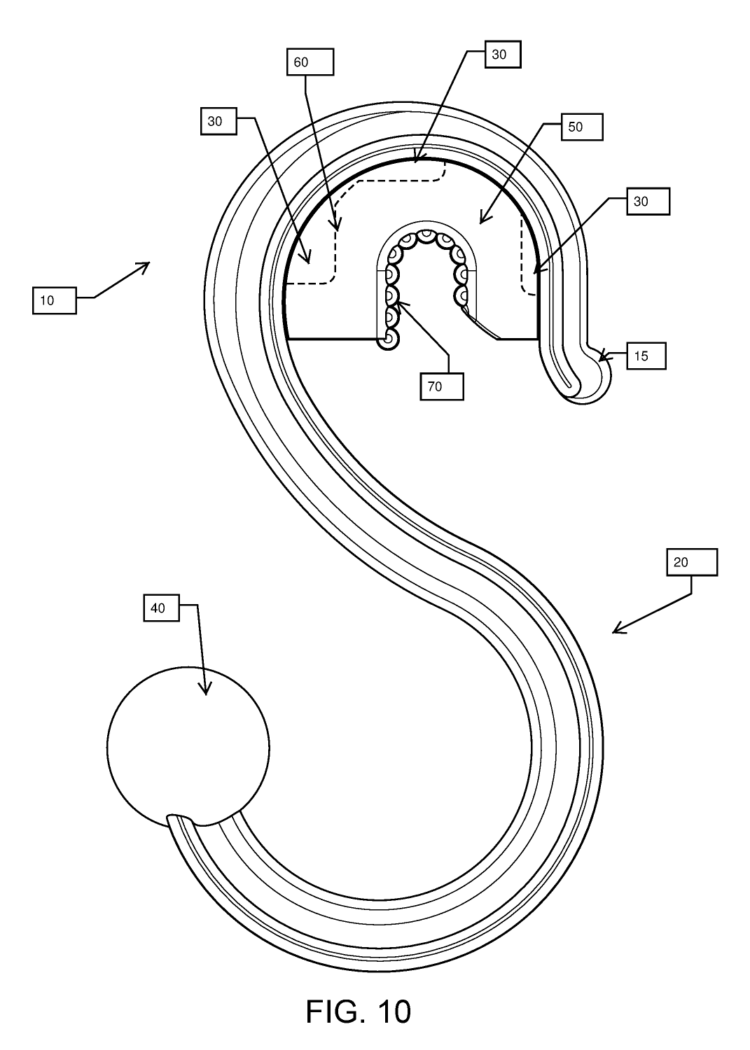

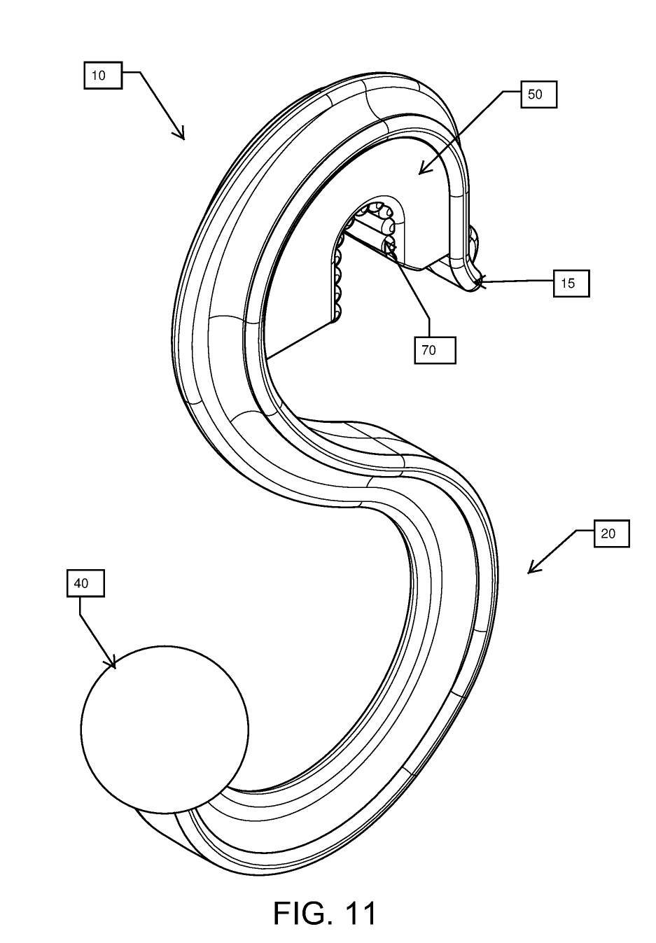

As shown more fully in FIGS. 10-11, the exterior portion of the U-shaped insert body 50 is mounted to the interior portion of the first U-shaped configuration of the “S” 10 using the mounting tabs or fins 30 lining the interior portion of the first U-shaped configuration of the “S” 10 to allow the hook to fit over a bar or rack and thereby holding the hook in a vertical position perpendicular to the bar or rack. The U-shaped insert generally fits onto the mounting tabs 30 using tension created by the mounting tabs 30 and the alignment with recessed portions 60. Alternatively, they can be mounted using a “press fit” or other method of attachment, such as hook and loop fastener.

It is contemplated that the hook device may be sold as a kit wherein the “S” shaped hook is combined with a variety of U-shaped inserts. Most towel bar rods (square or round) are one of the following sizes: ½″—⅝″—¾″. As such, the variety of U-shaped inserts have an interior cross sectional diameter that corresponds to fit onto the standard bar rods sizes in a press fit method using the gripping surface 70. However, it is contemplated the interior portion of the U-shaped insert may be flexible to allow a universal fit onto any towel bar or rod.

Additionally, as shown in FIGS. 1-2 and 10-11, the second U-shaped configuration 20 may have a spherically shaped portion protruding from its terminal end 40, which is useful for assuring that a towel or article of clothing hanging on the terminal end 40 remains firmly in place. However, the shape is not limited to a sphere as the terminal end 40 could be any variety of shapes to allow clothes to hang upon the hook.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A hook arrangement device for hanging items along a bar or rack comprising:
a. a generally S-shaped hook having an interior and exterior portion;
b. a first U-shaped configuration at one end of the S;
c. a plurality of mounting tabs protruding from the interior portion of the first U-shaped configuration;
d. a second U-shaped configuration at the other end of the S in inverted relationship to the first U-shaped end; and
e. a U-shaped insert with an interior and exterior portion
wherein the exterior portion of the U-shaped insert is mounted to the interior portion of the first U-shaped configuration using the mounting tabs of the interior portion of the first U-shaped configuration to allow the hook to fit over a bar or rack and thereby holding the hook in a vertical position perpendicular to the bar or rack.

2. The hook arrangement device of claim 1 further comprising a non-slip material fully or partially lining the interior of the U-shaped insert.

3. The hook arrangement device of claim 1 wherein the interior portion of the U-shaped insert has a substantially circular cross section.

4. The hook arrangement device of claim 1 wherein the interior portion of the U-shaped insert has a substantially rectangular cross section.

5. The hook arrangement device of claim 1 further comprising a plurality of U-shaped inserts that are interchangeably mounted to the interior portion of the first U-shaped configuration.

6. The hook arrangement device of claim 5 further comprising a non-slip material fully or partially lining the interior of each U-shaped insert.

7. The hook arrangement device of claim 5 wherein the interior portion of each U-shaped insert has a different cross sectional dimension.

8. The hook arrangement device of claim 7 wherein the interior portion of at least one the U-shaped inserts has a substantially circular cross section.

9. The hook arrangement device of claim 7 wherein the interior portion of at least one of the U-shaped inserts has a substantially rectangular cross section.

10. The hook arrangement device of claim 1 further comprising a spherically shaped portion protruding from a terminal end of the second U-shaped portion.

11. A hook arrangement device for hanging items along a bar or rack comprising:
a. a generally S-shaped hook having an interior and exterior portion;
b. a first U-shaped configuration at one end of the S;
c. a plurality of mounting tabs protruding from the interior portion of the first U-shaped configuration;
d. a second U-shaped configuration at the other end of the S in inverted relationship to the first U-shaped end;
e. a plurality of U-shaped inserts each having an interior and exterior portion that are interchangeably mounted to the interior portion of the first U-shaped configuration
wherein the interior portion of each U-shaped insert has a different cross sectional dimension
wherein the exterior portion of each U-shaped insert may be interchangeably mounted to the interior portion of the first U-shaped configuration using the mounting tabs of the interior portion of the first U-shaped configuration to allow the hook to fit over a bar or rack and thereby holding the hook in a vertical position perpendicular to the bar or rack.

12. The hook arrangement device of claim 11 further comprising a non-slip material fully or partially lining the interior of each U-shaped insert.

13. The hook arrangement device of claim 11 wherein the interior portion of at least one U-shaped insert has a substantially circular cross section.

14. The hook arrangement device of claim 11 wherein the interior portion of at least one U-shaped insert has a substantially rectangular cross section.

15. The hook arrangement device of claim 11 further comprising a spherically shaped portion protruding from a terminal end of the second U-shaped portion.

16. A kit for hanging items along a bar or rack comprising:
a. a generally S-shaped hook having an interior and exterior portion;
b. a first U-shaped configuration at one end of the S;
c. a plurality of mounting tabs protruding from the interior portion of the first U-shaped configuration;
d. a second U-shaped configuration at the other end of the S in inverted relationship to the first U-shaped end; and
e. a plurality of U-shaped inserts with an interior and exterior portion
wherein the interior portion of each U-shaped insert has a different cross sectional dimension; and
wherein the exterior portion of the U-shaped inserts are interchangeably mounted to the interior portion of the first U-shaped configuration using the mounting tabs of the interior portion of the first U-shaped configuration to allow the hook to fit over a bar or rack and thereby holding the hook in a vertical position perpendicular to the bar or rack.

17. The hook arrangement kit of claim 16 further comprising a non-slip material fully or partially lining the interior of each U-shaped insert.

18. The hook arrangement kit of claim 16 wherein the interior portion of at least one the U-shaped inserts has a substantially circular cross section.

19. The hook arrangement kit of claim 16 wherein the interior portion of at least one of the U-shaped inserts has a substantially rectangular cross section.

20. The hook arrangement kit of claim 16 further comprising a spherically shaped portion protruding from a terminal end of the second U-shaped portion.
